(19) United States
(12) Patent Application Publication
(10) Pub. No.: US 2010/0080744 A1
(43) Pub. Date: Apr. 1, 2010

(54) PROCESS FOR ISOLATING METALLIC RUTHENIUM OR RUTHENIUM COMPOUNDS FROM RUTHENIUM-CONTAINING SOLIDS

(75) Inventors: Timm Schmidt, Neuss (DE); Tim Loddenkemper, Dormagen (DE); Frank Gerhartz, Leverkusen (DE); Walther Müller, Pulheim (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/543,565

(22) Filed: Aug. 19, 2009

(30) Foreign Application Priority Data
Aug. 22, 2008 (DE) 102008039278.2

(51) Int. Cl. C01G 55/00; C22B 11/00; C22C 5/04

(52) U.S. Cl. 423/22; 423/491; 75/710; 75/426; 420/462

(57) ABSTRACT

The present invention relates to a process for mobilizing metallic ruthenium or ruthenium compounds from solids to form volatile ruthenium compounds by means of a gas stream containing a hydrogen halide and carbon monoxide, preferably hydrogen chloride and carbon monoxide, and for isolating the previously mobilized ruthenium compounds, preferably by deposition with cooling, e.g. in relatively cold zones, in particular on relatively cold surfaces, absorption in suitable solutions or adsorption on suitable support materials.

### RELATED APPLICATIONS

This application claims benefit to German Patent Application No. 10 2008 039 278.2, filed Aug. 22, 2008, which is incorporated herein by reference in its entirety for all useful purposes.

### BACKGROUND OF THE INVENTION

The present invention relates to a process for mobilizing metallic ruthenium or ruthenium compounds from solids to form volatile ruthenium compounds by means of a gas stream containing a hydrogen halide and carbon monoxide, preferably hydrogen chloride and carbon monoxide, and for isolating the previously mobilized ruthenium compounds, preferably by deposition with cooling, e.g. in relatively cold zones, in particular on relatively cold surfaces, absorption in suitable solutions or adsorption on suitable support materials.

A typical field of application for a solid containing metallic ruthenium or ruthenium compounds is its use as catalyst for the preparation of chlorine by thermal gas-phase oxidation of hydrogen chloride by means of oxygen:

4HCl+O₂ [symbol] 2Cl₂+2H₂O

This reaction is an equilibrium reaction. The position of the equilibrium shifts away from the desired end product as the temperature increases. It is therefore advantageous to use catalysts which have a very high activity and allow the reaction to proceed at a low temperature.

First catalysts for the oxidation of hydrogen chloride contained copper chloride or oxide as active component and were described by Deacon as early as 1868. However, these had only low activities at low temperature (<400° C.). Although their activity could be increased by increasing the reaction temperature, a disadvantage was that the volatility of the active components led to rapid deactivation.

Since no significant progress has been able to be achieved up to the 1960s despite tremendous research activities in this field, the Deacon process named after the discoverer was pushed into the background by chloroalkali electrolysis. Virtually the entire production of chlorine was carried out by electrolysis of aqueous sodium chloride solutions until the 1990s [Ullmann Encyclopedia of industrial chemistry, seventh release, 2006]. However, since the worldwide demand for chlorine is currently growing faster than the demand for sodium hydroxide, the attractiveness of the Deacon process remains since in this way hydrogen chloride, which is obtained in large quantities as coproduct in, for example, the phosgenation of amines, can be reused for the preparation of chlorine.

Significant progress in the field of hydrogen chloride oxidation was achieved by the discovery of ruthenium compounds as catalytically active components. Great progress has been achieved since then, especially in the provision of a suitable catalyst support. Particularly useful catalyst supports are titanium dioxide, whose use is described, for example, in the patent application EP 743 277 A1, and tin dioxide, whose use is known, for example, from the patent application DE 10 2006 024 543 A1.

Further typical fields of application for solids containing metallic ruthenium or ruthenium compounds in catalysis are the (selective) oxidation of carbon monoxide and exhaust air purification. U.S. Pat. No. 7,247,592 B2 describes a catalyst containing metallic ruthenium or ruthenium compounds for the selective oxidation of carbon monoxide. The use of catalysts containing metallic ruthenium or ruthenium compounds for a dual effect in the field of exhaust air treatment is known from U.S. Pat. No. 7,318,915 B2. Here, the catalyst described oxidizes carbon monoxide and volatile hydrocarbons while nitrous gases are reduced at the same time.

Further typical fields of application for solids containing metallic ruthenium or ruthenium compounds are electrodes for the preparation of chlorine by electrolysis of solutions containing sodium chloride and/or hydrogen chloride. In the electrolytic preparation of chlorine, dimensionally stable anodes (DSAs) are used, cf. Ullmann's Encyclopedia of Industrial Chemistry, 2006 Wiley-VCH-Verlag, Weinheim, pp. 57-62. Such anodes consist of titanium coated with a ruthenium-containing coating. Further typical constituents of such coatings are oxides of iridium, titanium, zirconium and tin.

A further use of solids containing ruthenium or ruthenium compounds is the electrolytic production of hydrogen. The electrolytic production of hydrogen is carried out using, according to Ullmann's Encyclopedia of Industrial Chemistry, 2006 Wiley-VCH-Verlag, Weinheim, pp. 62-63, not only other metals such as platinum, rhodium, Raney nickel but also ruthenium for reducing the hydrogen overvoltage. Such cathodes consist of nickel or stainless steel coated with a ruthenium-containing coating.

In addition, many further uses for solids containing metallic ruthenium or ruthenium compounds are known.

Various methods of isolating ruthenium from solids have already been described.

JP 3733909 B2 discloses a digestion process for isolating ruthenium from ruthenium-containing solids, in which an alkaline slurry is oxidized by addition of sodium hypochlorite and ruthenium is thereby selectively leached out. The mother liquor is subsequently reduced by means of an alcohol so that crystalline ruthenium hydroxide precipitates, and the latter is subsequently subjected to further purification steps.

WO 2008/062785 A1 discloses a three-stage process for recovering ruthenium from a solid on which a ruthenium compound is supported, by (i) reducing the ruthenium compounds by contacting with a reducing gas, (ii) cooling the solid to below 250° C. in a nonoxidizing atmosphere and (iii) mixing the solid with an oxidizing solution, resulting in ruthenium compounds going into solution.

DE 10 2005 061954 A1 discloses a three-stage process for recovering ruthenium from an exhausted ruthenium-containing catalyst which contains ruthenium as ruthenium oxide on a support material which is sparingly soluble in mineral acid, by (i) reduction in a stream of hydrogen, (ii) treatment of the reduced catalyst with hydrochloric acid in the presence of an oxygen-containing gas, resulting in ruthenium (III) chloride being formed and going into solution, and (iii) further work-up if appropriate.

JP 03-013531 A discloses a process for recovering ruthenium from residues containing ruthenium or ruthenium oxide. These are reacted with gaseous chlorine at elevated temperatures to form ruthenium chloride. The volatile ruthenium chloride is subsequently passed through a barium chloride solution and collected as water-soluble BaRuCI₅.

JP 58-194745 A discloses a process for recovering ruthenium, in which ruthenium oxides present on a corrosion-resistant support are firstly reduced to metallic ruthenium and subsequently converted into soluble alkali metal ruthenates.

EP 767243 B1 describes a process for recovering ruthenium from exhausted catalysts by mobilization of ruthenium compounds by means of gaseous hydrogen chloride. The mobilized metal chlorides are separated from one another by fractional distillation.

Goodwin, J. G. Jr. et. al., Appl. Cat., 1986, 24, 199, discloses that ruthenium carbonyls can be driven off by treatment of a solid containing ruthenium compounds with carbon monoxide.

In industry, the recovery of ruthenium is often dispensed with in the work-up of electrodes. In order to recover at least the uncoated metallic support, the thin layer containing mixed oxide on the surface of the electrodes is removed by means of sand blasting. The very low proportion of ruthenium in the sand makes recovery of ruthenium uneconomical in this case.

U.S. Pat. No. 5,141,563 discloses the recovery of ruthenium from used titanium electrodes in a multistage process in which the ruthenium-containing electrode coating is removed from the titanium support in a salt bath comprising potassium hydroxide and potassium nitrate at a temperature of from 300 to 450° C. in a first step. The electrode coating which has been removed from the titanium support is separated off from the salt bath, for example by filtration. The electrode coating which has been separated off is subsequently worked up in a further step to recover the ruthenium.

The as yet unpublished German application with number DE 10 2007 020 142.9 describes a four-stage process for recovering ruthenium from a ruthenium-containing, supported catalyst material by (i) chemical digestion of the catalyst material, (ii) production of a crude ruthenium salt solution, (iii) purification of the crude ruthenium salt solution and (iv) further treatment steps to isolate ruthenium chloride.

It is obvious that an easy-to-handle gas-phase process by means of which metallic ruthenium or ruthenium compounds can be mobilized from solids, in particular from solids which are insoluble in mineral acids, at moderate temperatures without complicated pretreatment, without the processing of solids slurries, in particular without mechanical pretreatment of the solid, and the previously mobilized ruthenium compounds can be recovered in a simple manner has yet to be developed. It is therefore an object of the present invention to provide a simple and efficient process for mobilizing metallic ruthenium or ruthenium compounds from solids and recovering the previously mobilized ruthenium compounds.

### Embodiments of the Invention

An embodiment of the present invention is a process for recovering metallic ruthenium or a ruthenium compound from a solid containing ruthenium or a ruthenium compound comprising treating said solid with a gas stream comprising a mixture of a hydrogen halide and carbon monoxide in a reaction zone at an elevated temperature to form at least one volatile ruthenium compound which is carried out by said gas stream and subsequently cooling the gas stream comprising said at least one volatile ruthenium compound.

Another embodiment of the present invention is the above process, wherein said solid containing ruthenium or a ruthenium compound is a solid catalyst or electrode material.

Another embodiment of the present invention is the above process, wherein said hydrogen halide is hydrogen chloride.

Another embodiment of the present invention is the above process, wherein said elevated temperature is at least 250° C.

Another embodiment of the present invention is the above process, wherein said cooling is achieved by depositing said at least one volatile ruthenium compound in a deposition zone which is colder than said reaction zone and/or absorbing said at least one volatile ruthenium compound in a solution and/or adsorbing said at least one volatile ruthenium compound on a support material.

Another embodiment of the present invention is the above process, wherein said deposition zone is a colder deposition surface.

Another embodiment of the present invention is the above process, wherein the hydrogen halide content of said mixture of a hydrogen halide and carbon monoxide in said gas stream entering the reaction zone is in the range of from 0.1 to 99.9% by volume.

Another embodiment of the present invention is the above process, wherein the carbon monoxide content of said mixture of a hydrogen halide and carbon monoxide in said gas stream entering the reaction zone is in the range of from 0.1 to 99.9% by volume.

Another embodiment of the present invention is the above process, wherein the sum of hydrogen halide and carbon monoxide in said mixture of a hydrogen halide and carbon monoxide in said gas stream entering the reaction zone is at least 0.2% by volume.

Another embodiment of the present invention is the above process, wherein said gas stream entering the reaction zone contains less than 10% by volume of oxygen.

Another embodiment of the present invention is the above process, wherein the superficial velocity of said gas stream entering the reaction zone is less than 10 cm/s.

Another embodiment of the present invention is the above process, wherein the gas stream comprising said at least one volatile ruthenium compound is cooled to a temperature of less than 250° C. to isolate solid ruthenium compounds.

Another embodiment of the present invention is the above process, wherein said solid containing ruthenium or a ruthenium compound is treated with an oxygen-containing gas stream in an oxidation phase before it is treated with said gas stream comprising a mixture of a hydrogen halide and carbon monoxide, wherein the oxygen content of said oxygen-containing gas stream is at least 0.1% by volume and said oxidation phase is carried out at a temperature of up to 700° C.

Another embodiment of the present invention is the above process, wherein said solid containing ruthenium or a ruthenium compound is treated with a gas stream comprising hydrogen halide in a halogenation phase before it is treated with said gas stream comprising a mixture of a hydrogen halide and carbon monoxide, wherein the hydrogen halide content of said gas stream comprising hydrogen halide is at least 0.1% by volume and said halogenation phase is carried out at a temperature of up to 700° C.

Another embodiment of the present invention is the above process, wherein the hydrogen halide in said gas stream comprising halogen halide is hydrogen chloride.

Another embodiment of the present invention is the above process, wherein said solid containing ruthenium or a ruthenium compound is treated with an oxygen-containing gas stream in an oxidation phase before is treated with said gas stream comprising hydrogen halide in said halogenation phase, wherein the oxygen content of said oxygen-containing gas stream is at least 0.1% by volume and said oxidation phase is carried out at a temperature of up to 700° C.

Another embodiment of the present invention is the above process, wherein the treatment of said solid containing ruthenium or a ruthenium compound with said gas stream comprising a mixture of a hydrogen halide and carbon monoxide is repeated one or more times.

Another embodiment of the present invention is the above process, wherein the treatment of said solid containing ruthenium or a ruthenium compound with said oxygen-containing gas stream is repeated one or more times.

Another embodiment of the present invention is the above process, wherein the treatment of said solid containing ruthenium or a ruthenium compound with said gas stream comprising hydrogen halide is repeated one or more times.

Yet another embodiment of the present invention is a catalyst or electrode coating comprising ruthenium or a ruthenium compound prepared by the above process.

### DESCRIPTION OF THE INVENTION

It has now surprisingly been found that metallic ruthenium or ruthenium compounds can be mobilized from solids by targeted treatment with a gas stream containing hydrogen halide and carbon monoxide, preferably hydrogen chloride and carbon monoxide, and the previously mobilized ruthenium compounds can be recovered with cooling, preferably by deposition in relatively cold zones, in particular on relatively cold surfaces, absorption in suitable solutions or adsorption on suitable support materials.

In the following passages, the wording “mobilization of metallic ruthenium or ruthenium compounds from solids” will also be rendered in abbreviated form as “mobilization of ruthenium compounds”, “mobilization” or similar wordings. These expressions refer, for the purposes of the invention, to the formation of volatile ruthenium compounds which are gaseous under the reaction conditions. Unless explicitly excluded, the term “ruthenium compound” also always encompasses “metallic ruthenium”.

The invention provides a process for recovering metallic ruthenium or ruthenium compounds from solids containing ruthenium or ruthenium compounds, in particular solid catalyst or electrode material, by treatment of the solid with a gas stream containing at least hydrogen halide and carbon monoxide, preferably hydrogen chloride and carbon monoxide, in a reaction zone at elevated temperature, preferably at at least 250° C., to form volatile ruthenium compounds which are carried out by the gas stream and subsequent cooling of the laden gas stream, preferably by deposition in a deposition zone which is colder than the reaction zone, in particular on colder deposition surfaces, and/or absorption in solutions and/or adsorption on support materials.

The process of the invention can thus be used for the mobilization and recovery of ruthenium compounds from solids.

The novel process is, in a preferred variant, carried out in three phases, with the third phase (mobilization phase) being the process of the invention, while pretreatments, which can be omitted if appropriate, are carried out in the first phase (oxidation phase) and in the second phase (halogenation phase).

In the oxidation phase of the preferred process, an oxygen-containing gas stream is passed through the solid containing ruthenium compounds, with the oxygen content of the gas stream being, in particular, at least 0.1% by volume, preferably from 10 to 50% by volume, and particular preference being given to using air. The oxidation phase is carried out at a temperature of up to 700° C., preferably at from 200° C. to 500° C., particularly preferably from 300° C. to 400° C. The duration of the oxidation phase is preferably up to 5 hours. The oxidation phase serves, in particular, to convert metallic ruthenium and organic ruthenium compounds (partially) into ruthenium oxides or ruthenium mixed oxides. This procedure is particularly advantageous when, for example, the ruthenium compound is present as ruthenium metal.

In the halogenation phase of the preferred process, a gas stream containing hydrogen halide, preferably hydrogen chloride, is passed through the solid containing ruthenium compounds, with the hydrogen halide content of the gas stream being at least 0.1% by volume, preferably at least 1% by volume, very particularly preferably at least 10% by volume. In a preferred embodiment, the gas stream contains less than 10% by volume of oxygen, particularly preferably less than 1% by volume and the gas stream is very particularly preferably oxygen-free. The halogenation phase is, in particular, carried out at a temperature of up to 700° C., preferably up to 500° C., particularly preferably at from 100° C. to 400° C. The duration of the halogenation phase is preferably up to 1 hour, particularly preferably at least >5 min. The halogenation phase serves, in particular, to convert ruthenium compounds, in particular ruthenium oxides and ruthenium mixed oxides, partially into ruthenium halides or ruthenium oxide halides, preferably ruthenium chlorides or ruthenium oxide chlorides.

In the mobilization phase, a gas stream containing hydrogen halide and carbon monoxide, preferably hydrogen chloride and carbon monoxide, is passed through the solid containing ruthenium compounds. Here, the hydrogen halide content of the hydrogen halide/CO mixture of the gas stream entering the reaction zone is, in particular, from 0.1 to 99.9% by volume, preferably from 1 to 99% by volume, particularly preferably from 10 to 90% by volume and very particularly preferably from 30 to 70% by volume.

The carbon monoxide content of the hydrogen halide/CO mixture of the gas stream entering the reaction zone is, in particular, from 0.1 to 99.9% by volume, preferably from 1 to 99% by volume, particularly preferably from 10 to 90% by volume and very particularly preferably from 30 to 70% by volume.

The sum of the two components hydrogen halide and CO is, in particular, at least 0.2% by volume, preferably at least 2% by volume, particularly preferably at least 20% by volume and very particularly preferably at least 60% by volume, of the gas stream entering the reaction zone.

The volume ratio of hydrogen halide to carbon monoxide in the gas stream entering the reaction zone is preferably from 0.1 to 10, particularly preferably from 0.3 to 3 and very particularly preferably from 0.5 to 2.

In a preferred embodiment, the gas stream entering the reaction zone contains less than 10% by volume of oxygen, particularly preferably less than 1% by volume and the gas stream is very particularly preferably oxygen-free.

In a further preferred embodiment of the process, the superficial velocity of the gas stream entering the reaction zone is less than 10 cm/s, particularly preferably less than 2 cm/s.

The mobilization phase of the novel process is carried out at elevated temperature, in particular at a temperature of at least 250° C., preferably at from 250° C. to 400° C., particularly preferably from 250° C. to 380° C., very particularly preferably from 300° C. to 350° C. If the temperature is too low, i.e. significantly below 250° C., the mobilization rate is slow and required duration becomes unnecessarily long. If the temperature is too high, i.e. significantly above 400° C., the proportion of other components of the solid, e.g. of titanium support material, and compounds thereof in the gas stream leaving the reaction zone can increase greatly. This is usually undesirable. If partial discharge of other components can be accepted or even is desired, it can be advantageous to raise the temperature to above 400° C. for some time. This can be necessary, for example, to break up mixed oxides, e.g. titanium-ruthenium mixed oxides, in electrode coatings.

The duration of the mobilization phase is preferably up to 10 hours. The optimum duration depends, in particular, on the ruthenium content of the solid, on the accessibility of the preparation of immobilized ruthenium in the solid, on the temperature, on the hydrogen halide content and carbon monoxide content of the gas stream and on the desired degree of recovery. The mobilization phase serves, in particular, to mobilize ruthenium compounds from the solid.

Further constituents of the gas stream in all three phases (the oxidation phase, halogenation phase, mobilization phase) can independently be, in particular, inert gases, e.g. nitrogen or argon. Experience has shown that the gases which can be used often contain, for technical reasons, impurities (in the order of <1000 ppm), e.g. chlorine and water, whose presence in these concentrations does not have an adverse effect on use according to the invention.

The hydrogen halide in that form in the halogenation phase or in the mobilization phase can also be replaced by substances or mixtures of substances which liberate hydrogen halide, i.e. especially hydrogen chloride, fluoride, bromide or iodide, under the process conditions described or substances or mixtures of substances whose hydrogen and halogen functions achieve an effect comparable to hydrogen halide as such under the process conditions described. An example which may be mentioned here is phosgene.

Carbon monoxide in that form in the mobilization phase can also be replaced by substances or mixtures of substances which liberate carbon monoxide under the process conditions described or substances or mixtures of substances whose carbonyl function has an effect comparable to that of carbon monoxide as such under the process conditions described. An example which may be mentioned here is phosgene.

In a preferred embodiment, the individual phases (oxidation phase, halogenation phase, mobilization phase) are carried out in succession a number of times. This can serve to remove deposits of carbon or carbon-containing compounds, which cover the ruthenium compounds, from the surface of the solid.

Preferred solids for use according to the invention are porous solids having ruthenium compounds immobilized on their (internal) surface area. Examples which may be mentioned here are catalysts containing ruthenium compounds. For use according to the invention, particular preference is given to porous solids on whose (internal) surface area ruthenium halides, in particular ruthenium chlorides, ruthenium oxide halides, in particular ruthenium oxide chlorides, or ruthenium oxides, either individually or in admixture, are deposited. Preference is likewise given to solids which have little or no porosity and on whose (exterior) surface ruthenium compounds are immobilized for use according to the invention. Examples which may be mentioned here are ruthenium-containing electrodes, e.g. for the electrolysis of sodium chloride or hydrogen chloride.

A particularly preferred application is the mobilization of ruthenium compounds from catalysts whose support has mainly a rutile structure. A further particularly preferred application is the mobilization of ruthenium compounds from catalysts whose support contains titanium dioxide, aluminium oxide, zirconium oxide or tin dioxide or mixtures thereof. A further particularly preferred application is the mobilization of ruthenium compounds from supported catalysts or all-active catalysts, characterized in that the support comprises SiO₂, SiC, Si₃N₄, zeolites, hydrothermally produced phosphates, clays, pillared clays, silicates or mixtures thereof.

In a preferred embodiment, porous solids are used in sieve fractions in the range from 0.1 mm to 50 mm, particularly preferably from 0.5 mm to 20 mm. These porous solids are particularly preferably subjected to the process of the invention without mechanical pretreatment. Mention may here be made by way of example of the many possible shaped catalyst bodies which can accordingly be used in the original state. A great advantage of this is that the formation of dusts of solids is avoided and the pressure drop is kept very low.

Solids having little or no porosity are, in a preferred embodiment, subjected to the process of the invention without mechanical pretreatment. Mention may here be made by way of example of ruthenium-containing electrodes for the electrolysis of sodium chloride or hydrogen chloride which, after the process of the invention has been carried out, can be recoated and reused.

In a particularly preferred embodiment, the ruthenium-containing catalyst solid remains in the same reactor in which the catalytic target reaction for which the solid is used is carried out for the time during which the novel process is carried out or at least for part of the time during which the novel process is carried out. As target reaction, mention may here be made by way of example of a process based on ruthenium catalysts for the thermal gas-phase oxidation of hydrogen chloride by means of oxygen.

The process of the invention is preferably used for renewing the catalyst for the catalytical gas-phase oxidation process known as the Deacon process. In the Deacon process, hydrogen chloride is oxidized to chlorine by means of oxygen in an exothermal equilibrium reaction, forming water vapour. The reaction temperature is usually from 150 to 500° C., and the usual reaction pressure is from 1 to 25 bar. Since the reaction is an equilibrium reaction, it is advantageous to work at the lowest possible temperatures at which the catalyst still has sufficient activity. Furthermore, it is advantageous to use oxygen in superstoichiometric amounts relative to hydrogen chloride. For example, a two- to four-fold excess of oxygen is customary. Since decreases in selectivity do not have to be feared, it can be economically advantageous to work at relatively high pressure and accordingly at a residence time longer than that at atmospheric pressure.

The catalytical oxidation of hydrogen chloride can be carried out adiabatically or preferably isothermally or approximately isothermally, batchwise but preferably continuously as a moving-bed or fixed-bed process, preferably as a fixed-bed process, particularly preferably in shell-and-tube reactors, over heterogeneous catalysts at a reactor temperature of from 180 to 500° C., preferably from 200 to 400° C., particularly preferably from 220 to 350° C., and a pressure of from 1 to 25 bar (from 1000 to 25 000 hPa), preferably from 1.2 to 20 bar, particularly preferably from 1.5 to 17 bar and in particular from 2.0 to 15 bar.

Customary reaction apparatuses in which the catalytical oxidation of hydrogen chloride is carried out are fixed-bed or fluidized-bed reactors. The catalytic oxidation of hydrogen chloride can preferably also be carried out in a plurality of stages.

The conversion of hydrogen chloride in a single pass can preferably be limited to from 15 to 90%, preferably from 40 to 90%, particularly preferably from 50 to 90%. Unreacted hydrogen chloride can be separated off and partly or wholly recirculated to the catalytic oxidation of hydrogen chloride.

In the adiabatic or approximately adiabatic mode of operation, it is also possible to use a plurality of reactors, i.e. from 2 to 10, preferably from 2 to 6, particularly preferably from 2 to 5, in particular 2 or 3, reactors, connected in series with additional intermediate cooling. The hydrogen chloride can either be introduced together with the oxygen upstream of the first reactor or its introduction can be distributed over the various reactors. This arrangement of individual reactors in series can also be combined in one apparatus.

A further preferred embodiment of an apparatus suitable for the Deacon process comprises using a structured catalyst bed in which the catalytical activity increases in the flow direction. Such structuring of the catalyst bed can be achieved by different impregnation of the catalyst support with active composition or by different dilution of the catalyst with an inert material. As inert material, it is possible to use, for example, rings, cylinders or spheres composed of titanium dioxide, zirconium dioxide or mixtures thereof, aluminium oxide, steatite, ceramic, glass, graphite or stainless steel. In the case of the preferred use of shaped catalyst bodies, the inert material should preferably have similar external dimensions.

Suitable and preferred catalysts for the Deacon process contain ruthenium oxides, ruthenium chlorides or other ruthenium compounds. Suitable support materials are, for example, silicon dioxide, graphite, titanium dioxide having a rutile or anatase structure, zirconium dioxide, aluminium oxide or mixtures thereof, preferably titanium dioxide, zirconium dioxide, aluminium oxide or mixtures thereof, particularly preferably γ- or δ-aluminium oxide or mixtures thereof. Suitable catalysts can, for example, be obtained by application of ruthenium (III) chloride to the support and subsequent drying or drying and calcination. Suitable catalysts can also contain, in addition to a ruthenium compound, compounds of other noble metals, for example gold, palladium, platinum, osmium, iridium, silver, copper or rhenium. Suitable catalysts can also contain chromium (III) oxide.

Suitable promoters for doping the catalysts are alkali metals such as lithium, sodium, potassium, rubidium and caesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, and mixtures thereof.

The shaping of the catalyst can be carried out after or preferably before impregnation of the support material. Suitable shaped catalyst bodies are shaped bodies having any shapes, with preference being given to pellets, rings, cylinders, stars, wagon wheels or spheres and particular preference is given to rings, cylinders or star extrudates as shape. The shaped bodies can subsequently be dried and if appropriate calcined at a temperature of from 100 to 400° C., preferably from 100 to 300° C., for example in a nitrogen, argon or air atmosphere. The shaped bodies are preferably firstly dried at 100 to 150° C. and subsequently calcined at from 200 to 400° C.

A preferred embodiment of the recovery of the mobilized ruthenium compounds is deposition of the ruthenium compounds with cooling, in particular in relatively cold zones and/or on relatively cold surfaces. Cooling fingers may be mentioned here by way of example. A further preferred embodiment for the recovery of the mobilized ruthenium compounds is absorption in suitable absorption solutions. An aqueous absorption solution may be mentioned here by way of example. If appropriate, oxidants or reducing agents can be added to the absorption solution. A preferred further embodiment for the recovery of the mobilized ruthenium compounds is adsorption on porous support materials, in particular coupled with a temperature decrease to a temperature of <250° C. A further preferred embodiment for the recovery of the mobilized ruthenium compounds comprises combinations of the above-described deposition methods.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Example 1

### Preparation of Solids Containing Ruthenium Compounds

To be able to illustrate the invention, shaped bodies containing ruthenium compounds supported on SnO₂ or TiO₂ were firstly produced.

### Example 1a

200 g of shaped SnO₂ bodies (spherical, diameter about 1.9 mm, 15% by weight of Al₂O₃ binder, Saint-Gobain) were impregnated with a solution of 9.99 g of ruthenium chloride n-hydrate in 33.96 ml of H₂O and subsequently mixed for 1 hour. The moist solid was subsequently dried at 60° C. in a muffle furnace (air) for 4 hours and then calcined at 250° C. for 16 hours.

### Example 1b

200 g of TiO₂ pellets (cylindrical, diameter about 2 mm, length from 2 to 10 mm, Saint-Gobain) were impregnated with a solution of 12 g of ruthenium chloride n-hydrate in 40.8 ml of H₂O and subsequently mixed for 1 hour. The moist shaped bodies obtained in this way were dried overnight at 60° C. and introduced in the dry state while flushing with nitrogen into a solution of NaOH and 25% hydrazine hydrate solution in water and allowed to stand for 1 hour. Excess water was subsequently evaporated. The moist shaped bodies were dried at 60° C. for 2 hours and subsequently washed with 4×300 g of water. The moist shaped bodies obtained in this way were dried at 120° C. in a muffle furnace (air) for 20 minutes and then calcined at 350° C. for 3 hours.

### Example 2

Influence of Carbon Monoxide, Hydrogen Chloride and Oxygen on the Mobilization of Ruthenium Compounds

4×1 g of the shaped bodies from Example 1a were placed in fused silica reaction tubes (diameter 10 mm), heated to 330° C., and a gas mixture 1 (10 l/h) composed of 1 l/h of hydrogen chloride, 4 l/h of oxygen, 5 l/h of nitrogen was passed through in each case for up to 16 hours (conditioning phase) and different gas mixtures were then passed through at 200° C. (2a-b) or 330° C. (2c-e) to form volatile ruthenium compounds (mobilization phase). The parameters for the mobilization phase are shown in Tab. 2a.

TABLE 2a
Parameters for the mobilization phase

| | | Example: | | | | |
|---|---|---|---|---|---|---|
| Phase | Parameter | 2a | 2b | 2c | 2d | 2e |
| Mobilization | Hydrogen chloride | — | 1 | 1 | — | 1 |
| phase | [l/h] | | | | | |
| | Carbon monoxide | 1.6 | 1.6 | — | 1.6 | 1.6 |
| | [l/h] | | | | | |
| | Oxygen [l/h] | — | — | — | — | — |
| | Nitrogen [l/h] | 8.4 | 7.4 | 9 | 8.4 | 7.4 |
| | Temperature [° C.] | 200 | 200 | 330 | 330 | 330 |
| | Time [h] | 18 | 14 | 18 | 16 | 14 |

After the mobilization phase, the decolorization of the shaped bodies and the formation of a characteristic deposit in a colder zone downstream of the reactors were evaluated as indicator for the volatilization of ruthenium compounds (Tab. 2b).

TABLE 2b
Decolorization of the shaped bodies; characteristic deposit in a
colder zone

| | Example: | | | | |
|---|---|---|---|---|---|
| | 2a | 2b | 2c | 2d | 2e |
| Decolorization | − | + | −− | − | ++ |
| Deposit | −− | + | −− | −− | ++ |

(none: −−, little: −, strong: +, very strong: ++)

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 2c).

TABLE 2c
Composition of the shaped bodies before and after mobilization of
ruthenium compounds and composition of the deposit in a colder
zone

| | | Example: | | | | | |
|---|---|---|---|---|---|---|---|
| Substrate | Metal component | 1a* | 2a | 2b | 2c | 2d | 2e |
| Batch | Ruthenium | 2.4 | n.d. | n.d. | 2.4 | n.d. | 0.56 |
| | [% by weight] | | | | | | |
| | Tin | 66 | n.d. | n.d. | 65 | n.d. | 65 |
| | [% by weight] | | | | | | |
| | Aluminium | 6.8 | n.d. | n.d. | 7.2 | n.d. | 7.4 |
| | [% by weight] | | | | | | |

*untreated sample,
n.d.: not determined

Ruthenium compounds can obviously not be mobilized from the shaped bodies used by means of hydrogen chloride in this temperature range (no decolorization, no deposit formation, no loss of ruthenium according to XRF). Ruthenium compounds can be mobilized only poorly by means of carbon monoxide in this temperature range (little decolorization, no deposit formation). When the two gases are combined, however, ruthenium compounds can be mobilized well or very well, in particular at elevated temperature (strong to very strong decolorization, strong to very strong deposit formation, ruthenium removal according to XRF).

### Example 3

### Influence of Conditioning on the Mobilization of Ruthenium Compounds by Means of Hydrogen Chloride and Carbon Monoxide

8×1 g of the shaped bodies from Example 1a were placed in fused silica reaction tubes (diameter 10 mm) and heated to 330° C. The batches then underwent up to three different conditioning phases (1-3). In the subsequent mobilization phase, the same conditions were set for all batches. The parameters for the conditioning phases and the mobilization phase are shown in Tab. 3a.

TABLE 3a
Parameters for the conditioning phases and the mobilization phase

| | | Example: | | | | | | | |
|---|---|---|---|---|---|---|---|---|---|
| Phase | Parameter | 3a | 3b | 3c | 3d | 3e | 3f | 3g | 3h |
| Conditioning | Hydrogen chloride | — | 1 | 1 | — | — | 1 | 1 | — |
| phase 1 | [l/h] | | | | | | | | |
| | Oxygen [l/h] | — | 4 | 4 | — | — | 4 | 4 | — |
| | Nitrogen [l/h] | — | 5 | 5 | — | — | 5 | 5 | — |
| | Time [h] | — | 16 | 16 | — | — | 16 | 16 | — |
| Conditioning | Hydrogen chloride | — | — | — | — | — | — | — | — |
| phase 2 | [l/h] | | | | | | | | |
| | Oxygen [l/h] | — | — | 4 | 4 | — | — | 4 | 4 |
| | Nitrogen [l/h] | — | — | 5 | 5 | — | — | 5 | 5 |
| | Time [h] | — | — | 2 | 2 | — | — | 2 | 2 |
| Conditioning | Hydrogen chloride | 1 | 1 | 1 | 1 | — | — | — | — |
| phase 3 | [l/h] | | | | | | | | |
| | Oxygen [l/h] | — | — | — | — | 2 | 2 | 2 | 2 |
| | Nitrogen [l/h] | 7 | 7 | 7 | 7 | 7 | 7 | 7 | 7 |
| | Time [h] | 1 | 1 | 1 | 1 | 1 | 1 | 1 | 1 |
| Mobilization | Hydrogen chloride | 1 | 1 | 1 | 1 | 1 | 1 | 1 | 1 |
| phase | [l/h] | | | | | | | | |
| | Oxygen [l/h] | 2 | 2 | 2 | 2 | 2 | 2 | 2 | 2 |
| | Nitrogen [l/h] | 7 | 7 | 7 | 7 | 7 | 7 | 7 | 7 |
| | Time [h] | 16 | 16 | 16 | 16 | 16 | 16 | 16 | 16 |

After the mobilization phase, the decolorization of the shaped bodies and the formation of a characteristic deposit in a colder zone downstream of the reactors were evaluated as indicator for the volatilization of ruthenium compounds (Tab. 3b).

TABLE 3b
Decolorization of the shaped body; characteristic deposit in a colder
zone

| | Example: | | | | | | | |
|---|---|---|---|---|---|---|---|---|
| | 3a | 3b | 3c | 3d | 3e | 3f | 3g | 3h |
| Decolorization | ++ | ++ | ++ | ++ | − | − | − | − |
| Deposit | ++ | ++ | ++ | ++ | −− | −− | −− | −− |

(none: −−, little: −, moderate: o, strong: +, very strong: ++)

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 3c).

TABLE 3c
Composition of the shaped bodies before and after mobilization of
ruthenium compounds and composition of the deposit in a colder
zone

| | | Example: | | | | |
|---|---|---|---|---|---|---|
| Substrate | Metal component | 1a* | 3b | 3c | 3f | 3g |
| Batch | Ruthenium | 2.4 | 0.3 | 0.21 | 2.7 | 3.2 |
| | [% by weight] | | | | | |
| | Tin [% by weight] | 66 | 71 | 68 | 64 | 59 |
| | Aluminium | 6.8 | 4.9 | 6.4 | 7.9 | 11 |
| | [% by weight] | | | | | |
| Deposit | Ruthenium [mg/l] | — | 110 | 96 | n.d. | n.d. |
| | Tin [mg/l] | — | 0.71 | 0 | n.d. | n.d. |
| | Aluminium [mg/l] | — | 0.1 | 0.15 | n.d. | n.d. |

*untreated sample,
n.d. = not determined

It is obviously not critical for the formation of volatile ruthenium compounds whether the ruthenium-containing shaped bodies are used in untreated form, after conditioning under Deacon conditions or after conditioning under oxidative conditions (conditioning phases 1-2). It is obviously critical whether hydrogen chloride or carbon monoxide is passed over the batch first (conditioning phase 3). When hydrogen chloride is passed over the batch first, then ruthenium compounds can subsequently be mobilized very well; if, on the other hand, carbon monoxide is passed over the batch first, the subsequent mobilization phase displays only little success. Presumably, carbon monoxide under nonoxidative conditions reduces the ruthenium compounds present on the catalyst to metallic ruthenium which cannot be mobilized well without reoxidation. The addition of hydrogen chloride obviously suppresses this process, where possible by (partial) chlorination of the ruthenium compounds immobilized on the surface of the solid. The increased aluminium and ruthenium contents of the samples 3f and 3g removed from the reactor are attributable to removal of tin.

The deposit obtained in a colder zone downstream of the reactor in the two successful experiments consists virtually entirely of ruthenium (>98% by weight of the metal in the deposit) in compounds not determined in more detail.

### Example 4

### Influence of the Temperature on the Mobilization of Ruthenium Compounds by Means of Hydrogen Chloride and Carbon Monoxide

6×1 g of the shaped bodies from Example 1a and 2×1 g of unimpregnated shaped bodies (based on SnO₂) were placed in fused silica reaction tubes (diameter 10 mm). All batches (4a-h) were conditioned by passing a gas mixture 1 (10 l/h) composed of 1 l/h of hydrogen chloride, 4 l/h of oxygen and 5 l/h of nitrogen through them at 330° C. for 16 hours.

After this conditioning, a gas mixture composed of 4 l/h of oxygen and 5 l/h of nitrogen (oxidation phase), then a gas mixture composed of 1 l/h of hydrogen chloride and 7 l/h of nitrogen (halogenation phase) and subsequently a gas mixture 5 composed of 1 l/h of hydrogen chloride, 2 l/h of carbon monoxide and 7 l/h of nitrogen (mobilization phase) were passed through all batches. These three phases were carried out a total of three times, with only nitrogen (7 l/h) being passed through some of the batches (4e-4h) during the oxidation phase. The parameters for the individual phases are shown in Tab. 4a.

TABLE 4a
Parameters for the individual phases

| | | Example: | | | | | | | |
|---|---|---|---|---|---|---|---|---|---|
| Phase | Parameter | 4a | 4b | 4c | 4d | 4e | 4f | 4g | 4h |
| Oxidation phase | Gas mixture | 3a | 3b | 3a | 3a | 3a/b | 3a/b | 3a/b | 3a/b |
| | Time [h] | 2 | 2 | 2 | 2 | 2 | 2 | 2 | 2 |
| | Temperature | 330 | 330 | 330 | 330 | 340 | 340 | 340 | 340 |
| | [° C.] | | | | | | | | |
| Halogenation | Gas mixture | 4 | 4 | 4 | 4 | 4 | 4 | 4 | 4 |
| phase | Time [h] | 0.25 | 0.25 | 0.25 | 0.25 | 0.25 | 0.25 | 0.25 | 0.25 |
| | Temperature | 250 | 250 | 300 | 300 | 340 | 380 | 340 | 380 |
| | [° C.] | | | | | | | | |
| Mobilization | Gas mixture | 5 | 5 | 5 | 5 | 5 | 5 | 5 | 5 |
| phase | Time [h] | 1.75 | 1.75 | 1.75 | 1.75 | 1.75 | 1.75 | 1.75 | 1.75 |
| | Temperature | 250 | 250 | 300 | 300 | 340 | 380 | 340 | 380 |
| | [° C.] | | | | | | | | |

After the mobilization phase, the decolorization of the shaped bodies and the formation of a characteristic deposit in a colder zone downstream of the reactors were evaluated as indicator for the volatilization of ruthenium compounds (Tab. 4b).

TABLE 4b
Decolorization of the shaped bodies; characteristic deposit in a
colder zone

| | Example: | | | | | | | |
|---|---|---|---|---|---|---|---|---|
| | 4a | 4b | 4c | 4d | 4e | 4f | 4g | 4h |
| Decolorization | + | + | ++ | ++ | ++ | o | −− | −− |
| Deposit | + | + | ++ | ++ | ++ | ++ | −− | ++ |

(none: −−, little: −, moderate: o, strong: +, very strong: ++)

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 4c).

TABLE 4c
Composition of the shaped bodies before and after mobilization of
ruthenium compounds and composition of the deposit in a colder zone

| | | Example: | | | | | | | | |
|---|---|---|---|---|---|---|---|---|---|---|
| Substrate | Metal component | 1a* | 4a | 4b | 4c | 4d | 4e | 4f | 4g | 4h |
| Batch | Ruthenium | 2.4 | 1.4 | 1.8 | 0.59 | 0.79 | 0.56 | 3.1 | n.d. | 0 |
| | [% by weight] | | | | | | | | | |
| | Tin [% by weight] | 66 | 69 | 68 | 69 | 69 | 68 | 66 | n.d. | 69 |
| | Aluminium | 6.8 | 6.1 | 6.0 | 5.9 | 5.7 | 6.1 | 6.7 | n.d. | 6.2 |
| | [% by weight] | | | | | | | | | |
| Deposit | Ruthenium [mg/l] | — | 129 | n.d. | n.d. | 199 | n.d. | 13 | n.p. | n.d. |
| | Tin [mg/l] | — | 2.14 | n.d. | n.d. | 1.1 | n.d. | 5500 | n.p. | n.d. |
| | Aluminium [mg/l] | — | 1.42 | n.d. | n.d. | 2.4 | n.d. | 0.14 | n.p. | n.d. |

*untreated sample,
n.d. = not determined,
n.p. = not present (in a sufficient amount)

Up to 340° C., the residual ruthenium content of the shaped bodies decreases with increasing temperature, and the degree of mobilization accordingly correlates with temperature. The deposit precipitated in a colder zone downstream of the reactor consists virtually entirely of ruthenium (>98% by weight of the metal content) in compounds not determined in more detail. Increasing the mobilization temperature to 380° C. obviously leads to mobilization of ruthenium compounds being reduced and mainly tin compounds being removed.

Reoxidation between the individual mobilization phases does not lead to an improvement in the degree of mobilization at the time intervals chosen. However, a reoxidation could be advantageous if the deposition of carbon on the catalyst observed during the mobilization phase were to severely limit the degree of mobilization.

### Example 5

### Influence of the CO/HCl Ratio on the Mobilization of Ruthenium Compounds by Means of Hydrogen Chloride and Carbon Monoxide

4×1 g of the shaped bodies from Example 1a were placed in four fused silica reaction tubes (diameter 10 mm). All batches (5a-d) were conditioned by passing a gas mixture 1 (10 l/h) composed of 1 l/h of hydrogen chloride, 4 l/h of oxygen and 5 l/h of nitrogen through them at 330° C. for 16 hours. Subsequently, a gas mixture 2 composed of 1 l/h of hydrogen chloride and 9 l/h of nitrogen was firstly passed through the batches for 15 minutes (halogenation phase) and the gas mixtures shown in Table 5a were subsequently passed through the batches for 3 hours to form volatile ruthenium compounds (mobilization phase).

TABLE 5a
Parameters for the mobilization phase

| | | Example: | | | |
|---|---|---|---|---|---|
| Phase | Parameter | 5a | 5b | 5c | 5d |
| Mobilization | Hydrogen chloride [l/h] | 0.25 | 0.75 | 1.25 | 1.75 |
| phase | Carbon monoxide [l/h] | 1.75 | 1.25 | 0.75 | 0.25 |
| | Nitrogen [l/h] | 8 | 8 | 8 | 8 |
| | Total flow [l/h] | 10 | 10 | 10 | 10 |

After the mobilization phase, the decolorization of the shaped bodies and the formation of a characteristic deposit in a colder zone downstream of the reactors were evaluated as indicator for the volatilization of ruthenium compounds (Tab. 5b).

TABLE 5b
Decolorization of the shaped bodies, characteristic deposit in a colder zone
(none: −−, little: −, moderate: ◯, strong: +, very strong: ++)

Example:

| | 5a | 5b | 5c | 5d |
|---|---|---|---|---|
| Decolorization | + | ++ | ++ | ◯ |
| Deposit | − | ++ | ++ | ◯ |

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 5c).

TABLE 5c
Composition of the shaped bodies before and after the mobilization of
ruthenium compounds and composition of the deposit in a colder zone

| | | Example: | | | | |
|---|---|---|---|---|---|---|
| Substrate | Metal component | 1a* | 5a | 5b | 5c | 5d |
| Shaped | Ruthenium | 2.4 | 2.3 | 1.2 | 1.3 | 2.0 |
| bodies | [% by weight] | | | | | |
| | Tin [% by weight] | 64 | 64 | 65 | 65 | 64 |
| | Aluminium | 6.8 | 7.8 | 7.7 | 7.8 | 7.7 |
| | [% by weight] | | | | | |
| Deposit | Ruthenium [mg/l] | — | n.p. | 86 | 140 | n.d. |
| | Tin [mg/l] | — | n.p. | 0.3 | 0.1 | n.d. |
| | Aluminium [mg/l] | — | n.p. | 3.4 | 0.9 | n.d. |

*untreated sample,
n.d. = not determined,
n.p. = not present (in a sufficient amount)

A moderate volume ratio of hydrogen chloride to carbon monoxide in the process gas obviously leads to a significantly higher degree of mobilization than a very high or very low ratio. The deposit which precipitates in a colder zone downstream of the reactor consists virtually entirely of ruthenium (>95% of the total metal content) in compounds which were not determined in more detail.

### Example 6

### Influence of the Proportion of Active Components (CO+HCl) on the Mobilization of Ruthenium Compounds by Means of Hydrogen Chloride and Carbon Monoxide

8×1 g of the shaped bodies from Example 1a were placed in four fused silica reaction tubes (diameter 10 mm). All samples (6a-6h) were conditioned by passing a gas mixture 1 (10 l/h) composed of 1 l/h of hydrogen chloride, 4 l/h of oxygen and 5 l/h of nitrogen through them at 330° C. for 16 hours. Subsequently, a gas mixture 2 composed of 1 l/h of hydrogen chloride and 9 l/h of nitrogen was firstly passed through the batches for 15 minutes (halogenation phase) and the gas mixtures shown in Table 6a were subsequently passed through the batches for 2 hours to form volatile ruthenium compounds (mobilization phase).

TABLE 6a
Parameters for the mobilization phase

| | | Example: | | | | | | | |
|---|---|---|---|---|---|---|---|---|---|
| Phase | Parameter | 6a | 6b | 6c | 6d | 6e | 6f | 6g | 6h |
| Mobilization | Hydrogen chloride [l/h] | 0.13 | 0.39 | 0.66 | 0.92 | 0.35 | 1.05 | 1.76 | 2.46 |
| phase | Carbon monoxide [l/h] | 0.22 | 0.66 | 1.09 | 1.53 | 0.59 | 1.76 | 2.93 | 4.1 |
| | Nitrogen [l/h] | 9.65 | 8.95 | 8.25 | 7.55 | 9.06 | 7.19 | 5.31 | 3.44 |
| | Total flow [l/h] | 10 | 10 | 10 | 10 | 10 | 10 | 10 | 10 |
| | Time [h] | 3 | 3 | 3 | 3 | 2 | 2 | 2 | 2 |

After the mobilization phase, the decolorization of the shaped bodies and the formation of a characteristic deposit in a colder zone downstream of the reactors were evaluated as indicator for the volatilization of ruthenium compounds (Tab. 6b).

TABLE 6b
Decolorization of the shaped bodies; characteristic deposit in a
colder zone

| | Example: | | | | | | | |
|---|---|---|---|---|---|---|---|---|
| | 6a | 6b | 6c | 6d | 6e | 6f | 6g | 6h |
| Decolorization | ◯ | ◯ | + | ++ | ◯ | + | ++ | ++ |
| Deposit | − | ◯ | + | ++ | ◯ | + | ++ | ++ |

(none: −−, little: −, moderate: ◯, strong: +, very strong: ++)

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 6c).

TABLE 6c
Composition of the shaped bodies before and after the mobilization of
ruthenium compounds and composition of the deposit in a colder zone

| | | Example: | | | | | | | | |
|---|---|---|---|---|---|---|---|---|---|---|
| Substrate | Metal component | 1a* | 6a | 6b | 6c | 6d | 6e | 6f | 6g | 6h |
| Shaped | Ruthenium | 2.4 | 2.3 | 2.0 | 1.6 | 1.3 | 2.1 | 1.4 | 1.2 | 0.95 |
| bodies | [% by weight] | | | | | | | | | |
| | Tin [% by weight] | 66 | 64 | 64 | 64 | 65 | 64 | 64 | 64 | 65 |
| | Aluminium | 6.8 | 7.8 | 7.9 | 7.9 | 7.8 | 7.7 | 7.4 | 7.8 | 7.5 |
| | [% by weight] | | | | | | | | | |
| Deposit | Ruthenium [mg/l] | — | n.d. | 72 | 100 | n.d. | n.d. | n.d. | n.d. | 150 |
| | Tin [mg/l] | — | n.d. | 0.4 | 0.1 | n.d. | n.d. | n.d. | n.d. | 0.4 |
| | Aluminium [mg/l] | — | n.d. | 0.9 | 0.9 | n.d. | n.d. | n.d. | n.d. | 0.5 |

*untreated sample,
n.d. = not determined

The degree of mobilization obviously increases with increasing partial pressure of the active components hydrogen chloride and carbon monoxide. The deposit precipitated in the colder zones downstream of the reactor consists virtually entirely of ruthenium (>98% of the total metal content) in compounds which were not determined in more detail.

### Example 7

### Influence of the Contact Time on the Mobilization of Ruthenium Compounds by Means of Hydrogen Chloride and Carbon Monoxide

4×1 g of the shaped bodies from Example 1a were placed in four fused silica reaction tubes (diameter 10 mm). All batches (7a-d) were heated to 330° C. and conditioned by passing a gas mixture 1 (10 l/h) composed of 1 l/h of hydrogen chloride, 4 l/h of oxygen and 5 l/h of nitrogen through them for 16 hours. Subsequently, a gas mixture 2 composed of 10% by volume of hydrogen chloride and 90% by volume of nitrogen was firstly passed through the batches for 15 minutes (halogenation phase) and an HCl/CO gas mixture was subsequently passed through the batches for 2 hours to form volatile ruthenium compounds (mobilization phase). The volume flows passed through the individual batches are shown in Tab. 7a.

TABLE 7a
Parameters for the mobilization phase

| | | Example: | | | |
|---|---|---|---|---|---|
| Phase | Parameter | 7a | 7b | 7c | 7d |
| Mobilization | Hydrogen chloride [l/h] | 0.35 | 1.05 | 1.76 | 2.46 |
| phase | Carbon monoxide [l/h] | 0.59 | 1.76 | 2.93 | 4.1 |
| | Nitrogen [l/h] | 0.94 | 2.81 | 4.69 | 6.56 |
| | Total flow [l/h] | 1.88 | 5.62 | 9.38 | 13.12 |

After the mobilization phase, the decolorization of the shaped bodies and the formation of a characteristic deposit in a colder zone downstream of the reactors were evaluated as indicator for the volatilization of ruthenium compounds (Tab. 7b).

TABLE 7b
Decolorization of the shaped bodies; characteristic deposit in a colder zone
(none: −−, little: −, moderate: ◯, strong: +, very strong: ++)

Example:

| | 7a | 7b | 7c | 7d |
|---|---|---|---|---|
| Decolorization | ++ | ++ | ++ | ++ |
| Deposit | ++ | ++ | ++ | ++ |

After this treatment, the shaped bodies were removed from the reactor, ground in a mortar and the ruthenium content was determined by means of X-ray fluorescence analysis (XRF). The deposit in the colder zones downstream of the reactors was washed out by means of hydrochloric acid (20% strength by weight hydrogen chloride). The composition of this washing solution was determined by means of emission spectroscopy (OES) (Tab. 7c).

TABLE 7c
Composition of the shaped bodies before and after the mobilization of
ruthenium compounds and composition of the deposit in a colder zone

| | | Example: | | | | |
|---|---|---|---|---|---|---|
| Substrate | Metal component | 1a* | 7a | 7b | 7c | 7d |
| Shaped | Ruthenium | 2.4 | 1.7 | 1.5 | 1.5 | 1.4 |
| bodies | [% by weight] | | | | | |
| | Tin [% by weight] | 66 | 65 | 65 | 65 | 65 |
| | Aluminium | 6.8 | 7.5 | 7.4 | 7.3 | 7.4 |
| | [% by weight] | | | | | |
| Deposit | Ruthenium [mg/l] | — | n.d. | n.d. | n.d. | 41 |
| | Tin [mg/l] | — | n.d. | n.d. | n.d. | 0.1 |
| | Aluminium [mg/l] | — | n.d. | n.d. | n.d. | 0.6 |

*untreated sample,
n.d. = not determined

The total flow obviously plays only a minor role in the degree of mobilization of ruthenium compounds. Mass transfer into the gas phase is obviously not limiting over a wide range of superficial velocity. The deposit precipitated in a colder zone downstream of the reactor consists virtually entirely of ruthenium (>98% by weight of the total metal content) in compounds which were not determined in more detail.

### Example 8

### Influence of the Support Component on the Mobilization of Ruthenium Compounds by Means of Hydrogen Chloride and Carbon Monoxide

1 g of the shaped bodies from Example 1b were placed in a fused silica reaction tube (diameter 10 mm) The batch (8a) was heated to 330° C. Subsequently, a gas mixture 1 composed of 0.75 l/h of hydrogen chloride and 9.25 l/h of nitrogen was firstly passed through this batch for 15 minutes (halogenation phase). After this halogenation phase, a gas mixture 2 composed of 0.75 l/h of hydrogen chloride, 0.75 l/h of carbon monoxide and 8.5% by volume of nitrogen was passed through the batch for 1.5 hours and a gas mixture 3 composed of 0.75 l/h of hydrogen chloride, 0.75 l/h of carbon monoxide and 1.5% by volume of nitrogen was subsequently passed through the batch for a further 1.5 hours to form volatile ruthenium compounds (mobilization phase).

After the mobilization phase, the decolorization of the shaped bodies and the formation of a characteristic deposit in a colder zone downstream of the reactors were evaluated as indicator for the volatilization of ruthenium compounds (Tab. 8a).

TABLE 8a
Decolorization of the shaped bodies; characteristic deposit in a colder zone
(none: −−, little: −, moderate: ◯, strong: +, very strong: ++)

| | Example: |
|---|---|
| | 8a |
| Decolorization | ++ |
| Deposit | ++ |

After this treatment, the shaped bodies were removed from the reactor, ground in a mortar and the ruthenium content was determined by means of X-ray fluorescence analysis (XRF). The deposit in a colder zone downstream of the reactors was washed out by means of hydrochloric acid (20% strength by weight hydrogen chloride). The composition of this washing solution was determined by means of emission spectroscopy (OES) (Tab. 8b).

TABLE 8b
Composition of the shaped bodies before and after the mobilization of
ruthenium compounds and composition of the deposit in a colder zone

Example:

| Substrate | Metal component | 1b* | 8a |
|---|---|---|---|
| Shaped | Ruthenium | 2.9 | 2.2 |
| bodies | [% by weight] | | |
| | Titanium | 57 | 54 |
| | [% by weight] | | |
| Deposit | Ruthenium [mg/l] | — | 97 |
| | Titanium [mg/l] | — | <1 |

*untreated sample

Ruthenium compounds can also obviously be removed from solids which consist mainly of titanium dioxide.

### Example 9

### Mobilization of Ruthenium Compounds from Titanium Electrodes by Means of Hydrogen Chloride and Carbon Monoxide

A mixed oxide comprising 30% by weight of ruthenium and 70% by weight of titanium oxide was applied to titanium electrodes (diameter: 15 mm, thickness: 2-3 mm) by means of a dip coating process (sol-gel-based with subsequent calcination at 500° C.) so that the specific ruthenium loading was 33 g/m². Five of these titanium electrodes coated in this way were placed in a fused silica reaction tube (diameter ˜25 mm). The batch (9a) was heated to 330° C. and a gas mixture 1 (10 l/h) composed of 4 l/h of oxygen and 6 l/h of nitrogen was passed through it for 2 hours (oxidation phase). Subsequently, a gas mixture 2 composed of 5 l/h of hydrogen chloride and 5 l/h of nitrogen was firstly passed through the batch for 15 minutes (halogenation phase) and a gas mixture 3 composed of 3 l/h of hydrogen chloride, 3 l/h of carbon monoxide and 4 l/h of nitrogen was subsequently passed through the batch for 3 hours to form volatile ruthenium compounds (mobilization phase).

After the mobilization phase, the formation of a characteristic deposit in a colder zone downstream of the reactor was evaluated as first indicator of the mobilization of ruthenium compounds (Tab. 9a).

TABLE 9a
Decolorization of the shaped bodies; characteristic deposit in a colder zone
(none: −−, little: −, moderate: ◯, strong: +, very strong: ++)

| | Example: |
|---|---|
| | 9a |
| Decolorization | n.m. |
| Deposit | ++ |

* untreated sample,
n.m. = not measurable

After this treatment, the titanium electrodes were removed from the reactor, and the ruthenium content was determined by means of X-ray fluorescence analysis (XRF). The deposit in the colder zones downstream of the reactors was washed out by means of hydrochloric acid (20% strength by weight hydrogen chloride). The composition of this washing solution was determined by means of emission spectroscopy (OES) (Tab. 9).

TABLE 9
Composition of the titanium electrodes before and after the mobilization of
ruthenium compounds and composition of the deposit in a colder zone

Example:

| Substrate | Metal component | 1c* | 9a |
|---|---|---|---|
| Titanium | Ruthenium [g/m²] | 33 | |
| electrode | Titanium | n.m. | n.m. |
| | [% by weight] | | |
| Deposit | Ruthenium [mg/l] | — | 8.9 |
| | Titanium [mg/l] | — | 8.4 |

n.m. = not measurable

Ruthenium compounds can obviously also be removed from the surface of the titanium electrodes.

1. A process for recovering metallic ruthenium or a ruthenium compound from a solid containing ruthenium or a ruthenium compound comprising treating said solid with a gas stream comprising a mixture of a hydrogen halide and carbon monoxide in a reaction zone at an elevated temperature to form at least one volatile ruthenium compound which is carried out by said gas stream and subsequently cooling the gas stream comprising said at least one volatile ruthenium compound.

2. The process of claim 1, wherein said solid containing ruthenium or a ruthenium compound is a solid catalyst or electrode material.

3. The process of claim 1, wherein said hydrogen halide is hydrogen chloride.

4. The process of claim 1, wherein said elevated temperature is at least 250° C.

5. The process of claim 1, wherein said cooling is achieved by depositing said at least one volatile ruthenium compound in a deposition zone which is colder than said reaction zone and/or absorbing said at least one volatile ruthenium compound in a solution and/or adsorbing said at least one volatile ruthenium compound on a support material.

6. The process of claim 6, wherein said deposition zone is a colder deposition surface.

7. The process of claim 1, wherein the hydrogen halide content of said mixture of a hydrogen halide and carbon monoxide in said gas stream entering the reaction zone is in the range of from 0.1 to 99.9% by volume.

8. The process of claim 1, wherein the carbon monoxide content of said mixture of a hydrogen halide and carbon monoxide in said gas stream entering the reaction zone is in the range of from 0.1 to 99.9% by volume.

9. The process of claim 1, wherein the sum of hydrogen halide and carbon monoxide in said mixture of a hydrogen halide and carbon monoxide in said gas stream entering the reaction zone is at least 0.2% by volume.

10. The process of claim 1, wherein said gas stream entering the reaction zone contains less than 10% by volume of oxygen.

11. The process of claim 1, wherein the superficial velocity of said gas stream entering the reaction zone is less than 10 cm/s.

12. The process of claim 1, wherein the gas stream comprising said at least one volatile ruthenium compound is cooled to a temperature of less than 250° C. to isolate solid ruthenium compounds.

13. The process of claim 1, wherein said solid containing ruthenium or a ruthenium compound is treated with an oxygen-containing gas stream in an oxidation phase before it is treated with said gas stream comprising a mixture of a hydrogen halide and carbon monoxide, wherein the oxygen content of said oxygen-containing gas stream is at least 0.1% by volume and said oxidation phase is carried out at a temperature of up to 700° C.

14. The process of claim 1, wherein said solid containing ruthenium or a ruthenium compound is treated with a gas stream comprising hydrogen halide in a halogenation phase before it is treated with said gas stream comprising a mixture of a hydrogen halide and carbon monoxide, wherein the hydrogen halide content of said gas stream comprising hydrogen halide is at least 0.1% by volume and said halogenation phase is carried out at a temperature of up to 700° C.

15. The process of claim 14, wherein the hydrogen halide in said gas stream comprising halogen halide is hydrogen chloride.

16. The process of claim 14, wherein said solid containing ruthenium or a ruthenium compound is treated with an oxygen-containing gas stream in an oxidation phase before is treated with said gas stream comprising hydrogen halide in said halogenation phase, wherein the oxygen content of said oxygen-containing gas stream is at least 0.1% by volume and said oxidation phase is carried out at a temperature of up to 700° C.

17. The process of claim 1, wherein the treatment of said solid containing ruthenium or a ruthenium compound with said gas stream comprising a mixture of a hydrogen halide and carbon monoxide is repeated one or more times.

18. The process of claim 13, wherein the treatment of said solid containing ruthenium or a ruthenium compound with said oxygen-containing gas stream is repeated one or more times.

19. The process of claim 13, wherein the treatment of said solid containing ruthenium or a ruthenium compound with said gas stream comprising hydrogen halide is repeated one or more times.

20. A catalyst or electrode coating comprising ruthenium or a ruthenium compound prepared by the process of claim 1.
